(19) United States
(12) Patent Application Publication
(10) Pub. No.: US 2016/0121955 A1
(43) Pub. Date: May 5, 2016

(54) HEAT TRANSFERING DEVICE

(71) Applicant: Yang-Cheng SHIH, Taichung City (TW)

(72) Inventor: Yang-Cheng SHIH, Taichung City (TW)

(21) Appl. No.: 14/862,889

(22) Filed: Sep. 23, 2015

(30) Foreign Application Priority Data
Oct. 30, 2014 (TW) 103219224

(51) Int. Cl. B62J 33/00

(52) U.S. Cl. CPC B62J 33/00

(57) ABSTRACT

A heat transferring device which is applied to a scooter or a motorcycle has a hose, a first fan, and a switching set. The hose has a first open end, a second open end, and an interior chamber. The first open end and the second open end communicate with the interior chamber of the hose. The first fan is assembled at the first open end. The switching set is electrically connected with the first fan. The heat transferring device can offer improved riding experience in summer or in winter by transferring heat.

### BACKGROUND OF THE INVENTION

1. Field of the Invention

The present invention relates to a heat transferring device, and more particularly to a heat transferring device applied to a scooter or a motorcycle.

2. Description of Related Art

Since a rider of a scooter or a motorcycle is exposed to an outside environment, an apparent air temperature perceived by the rider affects the riding experience. The apparent air temperature is a felt temperature related to air temperature, wind flow velocity, humidity, and so on.

In winter, air temperature of the outside environment is low. The rider should wear a jacket to resist cold weather. As the vehicle speeds up, the apparent air temperature descends.

In summer, air temperature and humidity of the outside environment are high, and ultraviolet rays emitted by sun are intense. The rider always puts on clothes with long sleeves to block ultraviolet rays. However, the clothes with long sleeves make the rider feel muggy.

To eliminate the uncomfortable experience of riding, the present invention provides a heat transferring device to mitigate or obviate the aforementioned problems.

### SUMMARY OF THE INVENTION

The main objective of the present invention is to provide a heat transferring device; the heat transferring device can improve riding experience of a scooter or a motorcycle.

The heat transferring device comprises a hose, a first fan, and a switching set; wherein the hose has a first open end, a second open end, and an interior chamber. The first open end and the second open end communicate with the interior chamber of the hose. The first fan is assembled at the first open end. The switching set is electrically connected with the first fan. The heat transferring device can offer improved riding experience in summer or in winter by transferring heat.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of a heat transferring device in accordance with a first embodiment of the present invention;

FIG. 2 is an exploded perspective view of the heat transferring device in FIG. 1;

FIG. 3 is an operational perspective view of the heat transferring device in FIG. 1 mounted on a scooter;

FIG. 4 is another operational perspective view of the heat transferring device in FIG. 1 mounted on a scooter;

FIG. 5 is an enlarged perspective view of the heat transferring device in FIG. 1; and

FIG. 6 is an operational exploded perspective view of a second embodiment of a heat transferring device in accordance with the present invention.

### DETAILED DESCRIPTION OF PREFERRED EMBODIMENT

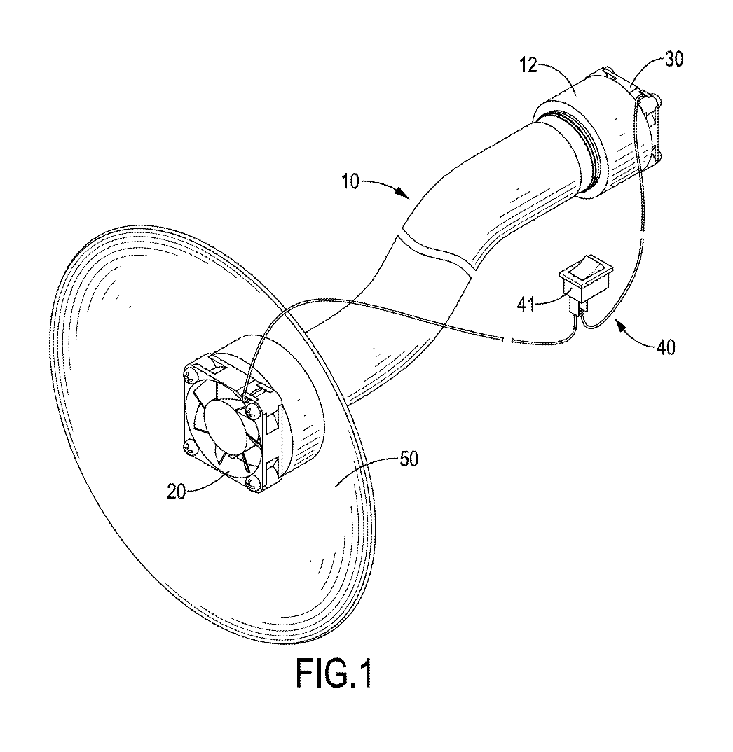

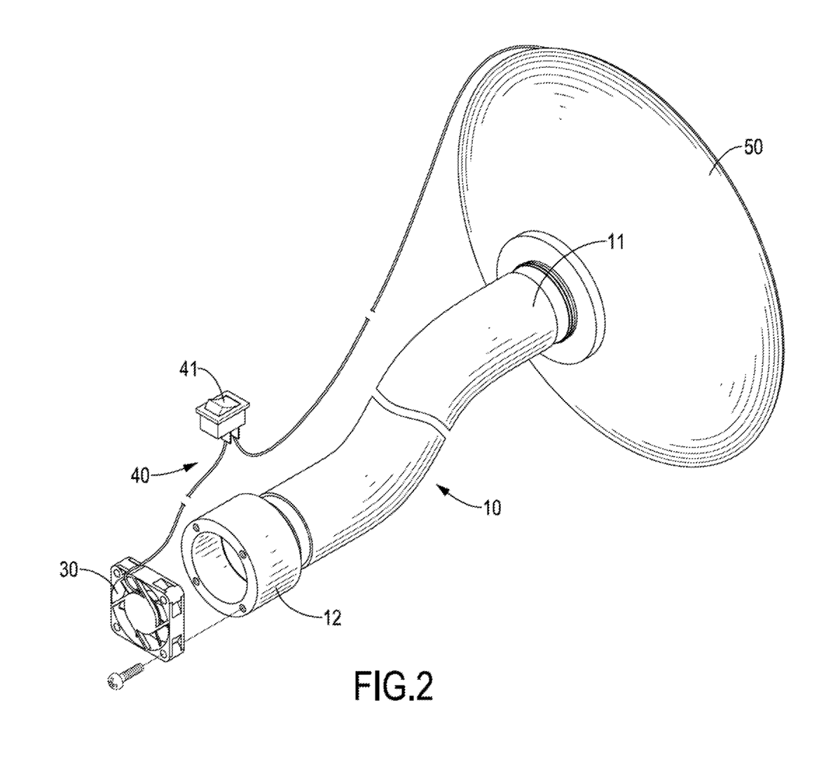

With reference to FIG. 1 and FIG. 2, a heat transferring device in accordance with the present invention comprises a hose 10, a first fan 20, a second fan 30, a switching set 40, and a covering part 50.

With reference to FIG. 1 and FIG. 2, the hose 10 has a first open end 11, a second open end 12, and an interior chamber. The first open end 11 is hollow and communicates with the interior chamber of the hose. The second end 12 is hollow and communicates with the interior chamber of the hose. The first fan 20 is assembled at the first open end 11 of the hose 10. The second fan 30 is assembled at the second open end 12 of the hose 10. The switching set 40 is electrically connected with the first fan 20 and the second fan 30. The switching set 40 has a switch 41. The covering part 50 is connected with the first open end 11 of the hose 10. The covering part 50 is funnel-shaped. The second fan 30 is optional and can be omitted. In practice, the heat transferring device can have the first fan 20 only and omits the second fan 30.

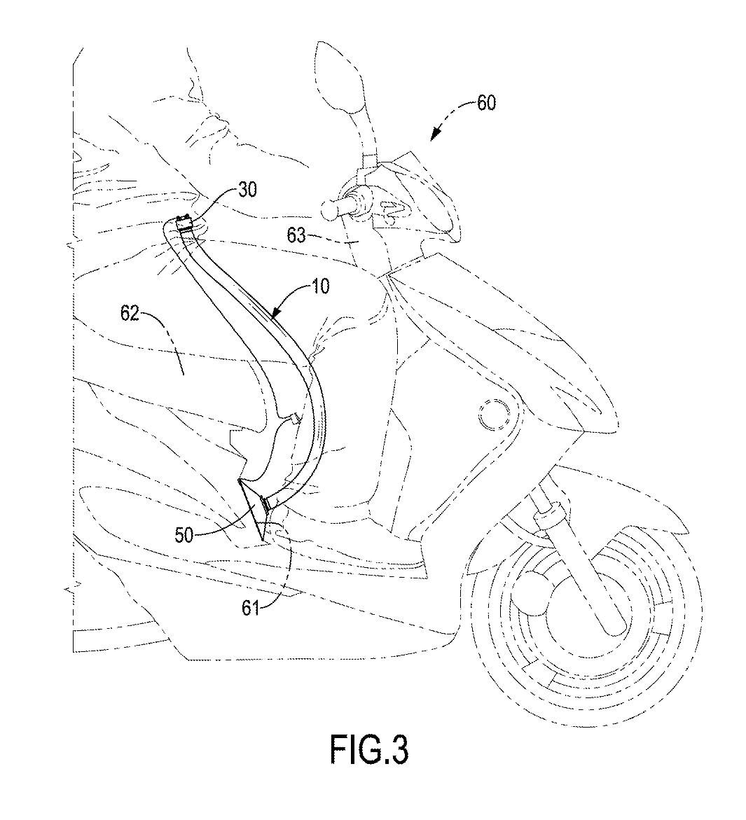

With reference to FIGS. 3, 4, and 6, the heat transferring device can be applied to a scooter 60 which has a vent 61, a seat 62, a steering control mechanism 63, an exhaust pipe 64, and an engine. The covering part 50 is mounted on the vent 61 of the scooter 60. The switching set 40, the first fan 20 and the second fan 30 are electrically connected with a battery of the scooter 60. A rider can switch the first fan 20 and the second fan 30 on or off by the switching set 40. The second fan 30 can be fixed on the seat 62 or connected with an inner side of the rider's clothes. The first fan 20 draws the warm air generated by the engine of the scooter 60 from the vent 61 when the engine of the scooter operates. The warm air passes through the hose 10, is drawn by the second fan 30, and eventually is conducted to the rider. The warm air can keep the rider warm in winter by the heat contained in the warm air. When the second fan 30 is omitted, the second open end 12 of the hose 10 can be fixed on the seat 62 of the scooter 60 or an inner side of the rider's clothes.

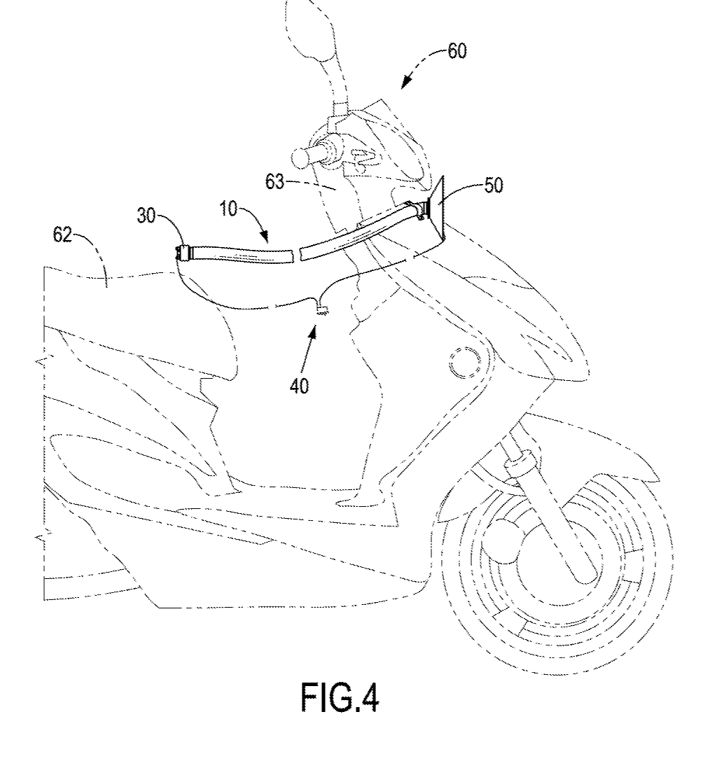

With reference to FIG. 4, the covering part 50 is fixed on the scooter 60 and is close to the steering control mechanism 63. The covering part 50 is oriented to a front of the scooter 60. The second fan 30 can be fixed on the seat 62 of the scooter 60 or an inner side of the rider's clothes. The covering part 50 collects cool air from the front of the scooter 60. Then the cool air is drawn into the hose 10 by the first fan 20. Finally, the second fan 30 blows the cool air to the rider. When the rider wears clothes with long sleeves to block ultraviolet rays in summer, the cool air drawn by the second fan 30 can take away the heat generated by rider's body and achieves a cooling effect.

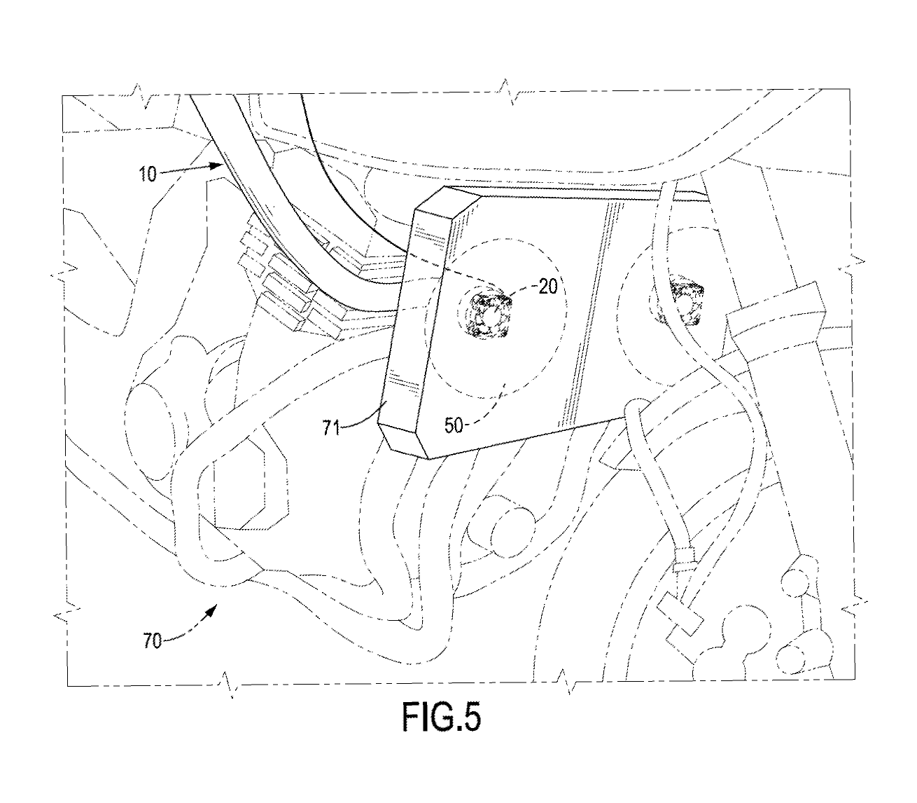

With reference to FIG. 5, the heat transferring device can also be applied to a motorcycle 70. The motorcycle 70 has an engine radiator 71, a seat, and an engine. The engine radiator 71 is utilized to dissipate the heat generated by the engine of the motorcycle 70. The covering part 50 can be fixed on a rear portion of the engine radiator 71. The second fan 30 is fixed on the seat of the motorcycle 70 or is fixed to an inner side of the rider's clothes. The first fan 20 draws the warm air containing heat that is radiated from the engine radiator 71 into the hose 10. The second fan 30 draws the warm air from the hose 10 and blows the warm air to a rider who rides on the motorcycle 70. The heat transferring device can be implemented as two in amount to accommodate a larger engine radiator. In addition, the covering part 50 can also be fixed on an engine oil cooler of the motorcycle 70.

The heat transferring device can omit the covering part 50, and the second fan 30 is directly fixed on the engine radiator, the steering control mechanism or the vent of a motor vehicle.

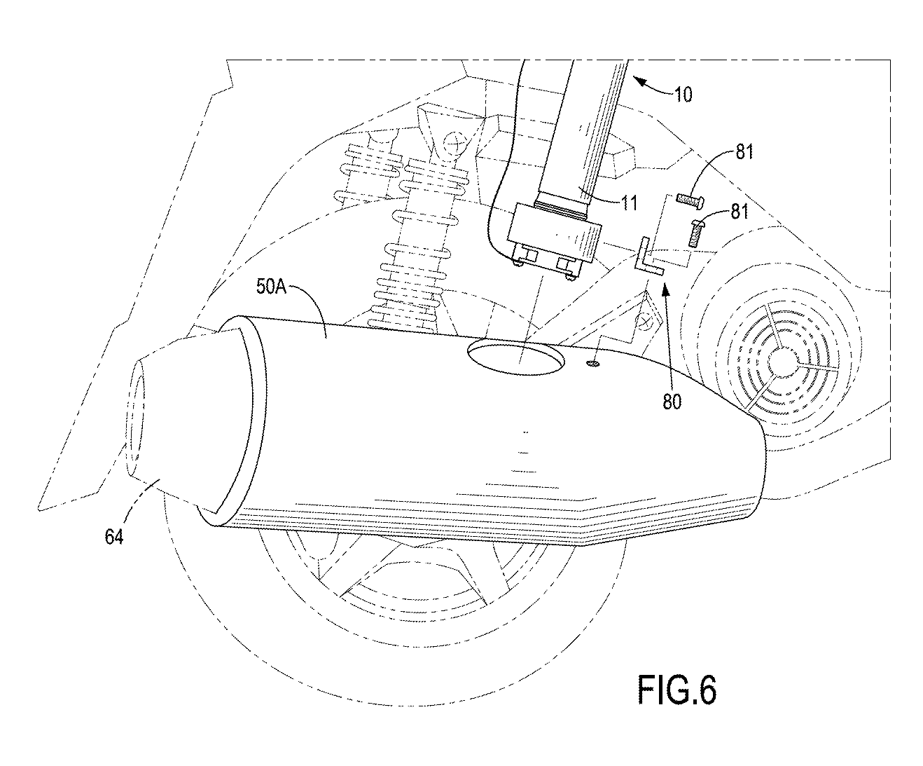

With reference to FIG. 6, in the second embodiment, the heat transferring device has a covering part 50A, which is tubular. The covering part 50A is also connected to the first open end 11 of the hose 10. The covering part 50A is connected to the first open end 11 by a connecting sheet 80 and two bolts 81. The two bolts 81 are mounted through the connecting sheet 80 and are respectively screwed with the first open end 11 and the covering part 50A. The covering part 50A covers the exhaust pipe 64 of the scooter 60. The exhaust pipe 64 has a high temperature. The heat transferring device can effectively blows the warm air to the rider. The covering part 50 can also prevent the rider or passengers from being burned by the exhaust pipe 64.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A heat transferring device comprising:
a hose having a first open end, a second open end, and an interior chamber;
a first fan assembled at the first open end and communicating with the interior chamber; and
a switching set electrically connected with the first fan.

2. The heat transferring device as claimed in claim 1 further comprising a second fan, wherein
the second fan is assembled at the second open end and is connected with the interior chamber; and the switching set is electrically connected with the second fan.

3. The heat transferring device as claimed in claim 2 further comprising a covering part, wherein the covering part is connected at the first open end.

4. The heat transferring device as claimed in claim 3, wherein the covering part is funnel-shaped.

5. The heat transferring device as claimed in claim 3, wherein the covering part is tubular.

6. The heat transferring device as claimed in claim 1 further comprising a covering part, wherein the covering part is connected at the first open end.

7. The heat transferring device as claimed in claim 6, wherein the covering part is funnel-shaped.

8. The heat transferring device as claimed in claim 6, wherein the covering part is tubular.
